(19) United States
(12) Patent Application Publication
(10) Pub. No.: US 2025/0044784 A1
(43) Pub. Date: Feb. 6, 2025

(54) STATE DETECTION APPARATUS, STATE DETECTION METHOD, GENERATION METHOD OF LEARNING MODEL, AND RECORDING MEDIUM

(71) Applicant: Tokyo Electron Limited, Tokyo (JP)

(72) Inventor: Ryoji ANZAKI, Sapporo City (JP)

(73) Assignee: Tokyo Electron Limited, Tokyo (JP)

(21) Appl. No.: 18/919,487

(22) Filed: Oct. 18, 2024

Related U.S. Application Data
(63) Continuation of application No. PCT/JP2023/015345, filed on Apr. 17, 2023.

(30) Foreign Application Priority Data
Apr. 18, 2022 (JP) 2022-068334

(51) Int. Cl. G05B 23/02

(52) U.S. Cl. CPC G05B 23/0281

(57) ABSTRACT

Provided is a state detection apparatus, a state detection method, a generation method of a learning model, and a recording medium, which can be expected to accurately detect a state of a target apparatus such as a semiconductor manufacturing apparatus. The state detection apparatus according to the present embodiment includes: a first acquirer that acquires input data of a target apparatus and observed data of an operation of the target apparatus; a determinator that determines parameters of an estimation model that estimates the observed data from the input data based on the input data and the observed data acquired by the first acquirer; and a detector that detects a state of the target apparatus based on the parameters determined by the determinator.

### CROSS-REFERENCE TO RELATED APPLICATIONS

This application is a bypass continuation application of international application No. PCT/JP2023/015345 having an international filing date of Apr. 17, 2023 and designating the United States, the international application being based upon and claiming the benefit of priority from Japanese Patent Application No. 2022-068334, filed on Apr. 18, 2022, the entire contents of each are incorporated herein by reference.

### TECHNICAL FIELD

The present disclosure relates to a state detection apparatus, a state detection method, a generation method of a learning model, and a recording medium.

### BACKGROUND

Japanese Unexamined Patent Application Publication No. 2020-128013 proposes a state determination apparatus that generates a learning model by acquiring data related to an industrial machine, creating a plurality of partial time series data obtained by sliding time series data of physical quantities in data related to the industrial machine in a time axis direction based on the acquired data related to the industrial machine, extracting a plurality of learning data that include the plurality of partial time series data, and performing machine learning using the extracted learning data.

### SUMMARY

A state detection apparatus according to one aspect of the present disclosure includes: a first acquirer that acquires input data of a target apparatus and observed data of an operation of the target apparatus; a determinator that determines parameters of an estimation model that estimates the observed data from the input data based on the input data and the observed data acquired by the first acquirer; and a detector that detects a state of the target apparatus based on the parameters determined by the determinator.

### BRIEF DESCRIPTION OF DRAWINGS

FIG. 1 is a schematic diagram for explaining an example of an information processing system according to the present embodiment.

FIG. 2 is a block diagram illustrating an example of a configuration of a state detection apparatus according to the present embodiment.

FIG. 3 is a schematic diagram illustrating an example of a state detection model according to the present embodiment.

FIG. 4 is a flowchart illustrating an example of a procedure of a learning data generation process performed by the state detection apparatus according to the present embodiment.

FIG. 5 is a schematic diagram for explaining an outline of a parameter determination process of an estimation model according to the present embodiment.

FIG. 6 is a flowchart illustrating an example of a procedure of a state detection model generation process performed by the state detection apparatus according to the present embodiment.

FIG. 7 is a flowchart illustrating an example of a procedure of a state detection process performed by the state detection apparatus according to the present embodiment.

FIG. 8 is a schematic diagram illustrating an example of the state detection model included in the state detection apparatus according to Modification 1.

### DETAILED DESCRIPTION

Hereinafter, a specific example of an information processing system according to the embodiment of the present disclosure will be described with reference to the drawings. The present disclosure is not limited to these examples, and is defined by the claims, and is intended to include all modifications within the meaning and scope equivalent to the claims.

### System Overview

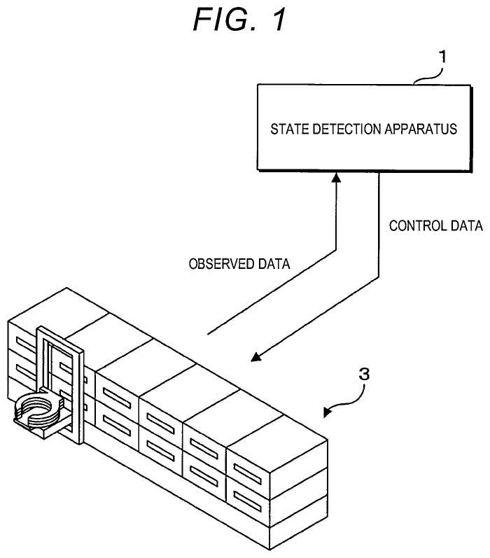

FIG. 1 is a schematic diagram for explaining an example of an information processing system according to the present embodiment. The information processing system according to the present embodiment includes a state detection apparatus 1 and a semiconductor manufacturing apparatus (target apparatus) 3. The illustrated semiconductor manufacturing apparatus 3 is an apparatus for transferring a wafer in a semiconductor manufacturing process. For example, the semiconductor manufacturing apparatus 3 transfers the wafer held by a fork by moving the fork holding the wafer using a mechanism such as a motor and a pulley (not illustrated). The state detection apparatus 1 is an apparatus that detects an operation state of the semiconductor manufacturing apparatus 3 and controls the operation of the semiconductor manufacturing apparatus 3 according to the detected operation.

The state detection apparatus 1 and the semiconductor manufacturing apparatus 3 are connected to each other through, for example, a cable such as a communication line or a signal line. The state detection apparatus 1 inputs, for example, control data for driving the motor that moves the fork into the semiconductor manufacturing apparatus 3. The control data includes, for example, information such as a driving amount of the motor. The semiconductor manufacturing apparatus 3 drives the motor in accordance with the input control data to move the fork and transfer the wafer. Further, the semiconductor manufacturing apparatus 3 includes various sensors for observing a transfer operation of the wafer. The semiconductor manufacturing apparatus 3 detects information related to an operation of the apparatus according to the control data, for example, a movement amount, a movement angle, a speed, an acceleration, or the like, by a sensor, and outputs observed data including the detected information to the state detection apparatus 1. An example of the sensor for obtaining observed data may include a camera that captures images (still images or moving images), or a microphone that acquires sound. The observed data may include an image captured by the camera or data such as sound acquired by the microphone.

The state detection apparatus 1 acquires control data input to the semiconductor manufacturing apparatus 3 and observed data output from the semiconductor manufacturing apparatus 3 that has performed an operation in accordance with the control data, and stores a set of control data and observed data as a history related to semiconductor manufacturing. Each time one operation of the semiconductor manufacturing apparatus 3 is ended, the state detection apparatus 1 reads time series information of the control data and the observed data related to the one operation, and detects the state of the semiconductor manufacturing apparatus 3 based on these time series information. For example, for one operation of the semiconductor manufacturing apparatus 3, various operation units, such as until the fork starts to move from a certain point and stops at another point, until the fork holds the wafer at a certain point and releases the wafer at another point, or until the fork returns to the original point after the start of the movement, may be adopted. Further, the state of the semiconductor manufacturing apparatus 3 detected by the state detection apparatus 1 is set to two states of abnormality and no abnormality in the present embodiment, but the present disclosure is not limited thereto. The state of the semiconductor manufacturing apparatus 3 may be, for example, a state in which the degree of abnormality between no abnormality and abnormality is classified by five stages or the like, or for example, may include a state immediately after maintenance or immediately after component replacement, in addition to the abnormality and no abnormality.

Further, the state of the semiconductor manufacturing apparatus 3 detected by the state detection apparatus 1 may include, for example, a numerical value indicating the degree of abnormality. As the numerical value indicating the degree of abnormality, for example, a decimal number in the range of 0.0 to 1.0, or a percentage in the range of 0% to 100%, or the like may be adopted. In addition, as the numerical value indicating the degree of abnormality, various numerical values such as a period until the predicted failure, a period required for the repair, or a cost required for the repair may be adopted. Further, the detected state may include a state represented by a combination of a plurality of numerical values, for example, “failure with a probability of 70% or more within 90 days”, or the like.

Further, the state of the semiconductor manufacturing apparatus 3 detected by the state detection apparatus 1 may include not only a state related to a future prediction such as the possibility that abnormality occurs in the semiconductor manufacturing apparatus 3, but also a state related to a past estimation, such as the probability that a certain event occurred in the past or has occurred. As the state related to the past estimation, various states such as whether the maintenance of the semiconductor manufacturing apparatus 3 has been performed, the estimated number of days for which the maintenance has been performed several days ago, or the percentage value that estimates the possibility that the maintenance has been performed within 10 days, may be adopted. Further, the detected state may include a state represented by a combination of a plurality of numerical values, for example, “maintenance has been performed with a probability of 10% or less within 10 days”, or the like.

The state detection apparatus 1 of the present embodiment performs a process of determining parameters of an estimation model that estimates an operation of the semiconductor manufacturing apparatus 3, based on time series information of the control data and the observed data. The estimation model is a model that receives the control data as an input and outputs predicted data obtained by predicting the observed data, and in the present embodiment, the estimation model is a non-integer order differential equation model. The non-integer order differential equation may also be referred to as a fractional differential equation. Since the non-integer order differential equation is a known mathematical concept (for example, see Nobumasa Sugimoto, “On differential and integral calculus of non-integer order”, The Mathematical Society of Japan, February 2017, Japanese Journal of Mathematics Vol. 21, No. 4, pp. 5-22), a detailed description thereof will be omitted. However, the estimation model is not limited to the non-integer order differential equation model, and may be, for example, an integer order differential equation model, or may be a model represented by any equation.

The state detection apparatus 1 calculates the fitness of the model by inputting the control data to the estimation model with the determined parameters, acquiring the estimated data output from the estimation model, and comparing the estimated data with the original observed data. In the present embodiment, a root mean squared error (RMSE) is used as the fitness. However, the present disclosure is not limited thereto, and indicators different from the RMSE may be used as the fitness. The state detection apparatus 1 compares the calculated fitness with a predetermined threshold value, for example, and detects the state of the semiconductor manufacturing apparatus 3 based on the comparison result. For example, the state detection apparatus 1 can detect the presence of abnormality in the semiconductor manufacturing apparatus 3 when the calculated RMSE exceeds the threshold value.

Further, the state detection apparatus 1 according to the present embodiment detects the state of the semiconductor manufacturing apparatus 3 based on the determined parameters of the estimation model. In the information processing system according to the present embodiment, the parameters of the estimation model are received as inputs, and a learning model for classifying the state of the semiconductor manufacturing apparatus 3 is generated in advance through machine learning. The state detection apparatus 1 includes a learning model generated in advance, and detects the state of the semiconductor manufacturing apparatus 3 by inputting the determined parameters of the estimation model to the learning model, and acquiring the classification result of the state output by the learning model.

The learning model used by the state detection apparatus 1 may be a model in which machine learning has been performed to classify the state of the semiconductor manufacturing apparatus 3 by receiving the above-described fitness and parameters as inputs. The state detection apparatus 1 determines the parameters of the estimation model, inputs the control data to the estimation model to calculate fitness, and inputs the calculated fitness and the determined parameters of the estimation model to the learning model in which machine learning has been performed in advance. The state detection apparatus 1 can detect the state of the semiconductor manufacturing apparatus 3 by acquiring output information of the learning model. Further, the learning model may be a model in which machine learning has been performed to further receive information different from the fitness and the parameters as inputs and classify the state of the semiconductor manufacturing apparatus 3.

When abnormality is detected in the state of the semiconductor manufacturing apparatus 3, the state detection apparatus 1 stops the operation of the semiconductor manufacturing apparatus 3, and displays a warning message or the like on a display such as a liquid crystal display, for example.

In the present embodiment, the target apparatus for detecting a state by the state detection apparatus 1 is the semiconductor manufacturing apparatus 3 that transfers the wafer, but the present disclosure is not limited thereto. The target apparatus for state detection may be any semiconductor manufacturing apparatus, or may be an apparatus other than the semiconductor manufacturing apparatus.

### <Apparatus Configuration>

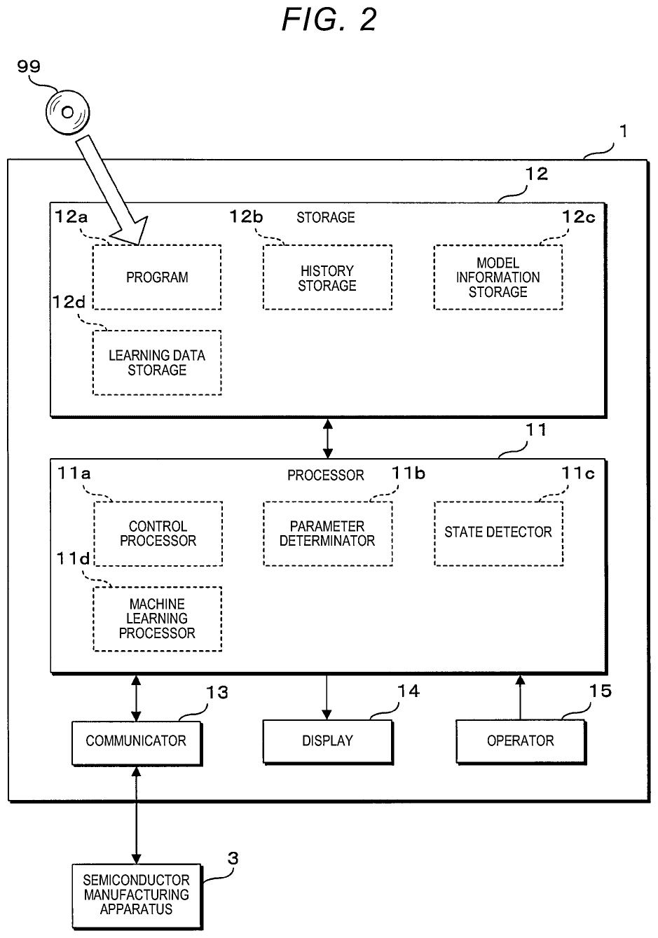

FIG. 2 is a block diagram illustrating an example of a configuration of the state detection apparatus 1 according to the present embodiment. The state detection apparatus 1 according to the present embodiment includes a processor 11, a storage 12, a communicator (transceiver) 13, a display 14, an operator 15, and the like. In the present embodiment, a process that is performed by one state detection apparatus 1 is described, but the process of the state detection apparatus 1 may be performed in a distributed manner by a plurality of apparatuses.

The processor 11 is configured by using an arithmetic processing apparatus such as a central processing unit (CPU), a micro-processing unit (MPU), a graphics processing unit (GPU), or a quantum processor, a read only memory (ROM), a random access memory (RAM), and the like. The processor 11 reads and executes a program 12a stored in the storage 12, thereby performing various processes such as a process of controlling the operation of the semiconductor manufacturing apparatus 3 and a process of detecting the state of the semiconductor manufacturing apparatus 3.

The storage 12 is configured by using, for example, a large-capacity storage apparatus such as a hard disk. The storage 12 stores various types of programs to be executed by the processor 11 and various types of data necessary for the process of the processor 11. In the present embodiment, the storage 12 stores the program 12a to be executed by the processor 11. Further, the storage 12 includes a history storage 12b that stores histories of the control data and the observed data, a model information storage 12c that stores information related to the learning model that classifies the state of the semiconductor manufacturing apparatus 3, and a learning data storage 12d that stores learning data used for machine learning to generate the learning model.

In the present embodiment, the program (computer program, program product) 12a is provided in the form recorded on a recording medium 99 such as a memory card or an optical disc, and the state detection apparatus 1 reads the program 12a from the recording medium 99 and stores the program 12a in the storage 12. However, the program 12a may be written into the storage 12 during a manufacturing stage of the state detection apparatus 1, for example. Further, for example, the program 12a may acquire distribution of a remote server apparatus or the like by the state detection apparatus 1 through communication. For example, the program 12a may be written into the storage 12 of the state detection apparatus 1 after a writing apparatus reads data recorded in the recording medium 99. The program 12a may be provided in the form of distribution through a network, or may be provided in the form recorded in the recording medium 99.

The history storage 12b of the storage 12 stores and accumulated, in a time series manner, information associated with the control data, which is input from the state detection apparatus 1 to the semiconductor manufacturing apparatus 3, and the observed data output from the semiconductor manufacturing apparatus 3 according to the control data. The history storage 12b holds the time series information of the acquired control data and observed data, which is acquired at least during one operation by the semiconductor manufacturing apparatus 3, that is, until the data necessary for the state detection apparatus 1 is acquired in order to detect the state of the semiconductor manufacturing apparatus 3. After the state detection apparatus 1 detects the state of the semiconductor manufacturing apparatus 3 based on the time series information for one operation, the history storage 12b may discard the time series information of the control data and the observed data, or may continue to hold the time series information.

The model information storage 12c stores information related to a model used by the state detection apparatus 1 for detecting the state of the semiconductor manufacturing apparatus 3. The information related to the model may include, for example, configuration information indicating the configuration of the model, and information such as values of parameters inside the model. The state detection apparatus 1 according to the present embodiment performs state detection using two models. The first model is a non-integer order differential equation model that receives an input of the control data and outputs predicted data obtained by predicting observed data. The parameters of the first model are determined each time the state detection apparatus 1 detects the state of the semiconductor manufacturing apparatus 3. This first learning model will be referred to as an “estimation model” hereinafter.

The second model is a learning model that receives the parameters of the first model (estimation model) as inputs, and classifies the state of the semiconductor manufacturing apparatus 3. The second model is a trained model in which the parameters have been determined through machine learning in advance. For example, learning models with various configurations such as a support vector machine (SVM), a decision tree, a random forest, or a deep neural network (DNN) may be adopted. In the present embodiment, for example, the state detection apparatus 1 generates a learning model in advance by performing a machine learning process using learning data prepared in advance by a developer or an operator of the information processing system. The state detection apparatus 1 stores information such as parameters of the learning model generated in advance in the model information storage 12c. Alternatively, the state detection apparatus 1 may acquire a trained learning model generated by another apparatus without performing the machine learning process, and may store the acquired learning model in the model information storage 12c for use. Hereinafter, the second learning model will be referred to as a “state detection model”.

The learning data storage 12d stores the learning data used for machine learning to generate a state detection model. In the present embodiment, the learning data is data obtained by associating the parameters of the estimation model with values indicating the state of the semiconductor manufacturing apparatus 3. The learning data may be referred to as labeled data used for so-called labeled machine learning. The learning data is generated in advance by, for example, operating the semiconductor manufacturing apparatus 3 to collect the control data and the observed data. The developer or operator of the information processing system according to the present embodiment performs a work for assigning a value indicating the state of the semiconductor manufacturing apparatus 3 to the collected control data and observed data, that is, a so-called annotation work. The state detection apparatus 1 acquires data in which the control data, the observed data, and values indicating the state of the semiconductor manufacturing apparatus 3 are associated with each other, and determines the parameters of the estimation model corresponding to the control data and the observed data. The state detection apparatus 1 can generate learning data by associating the value indicating the state of the semiconductor manufacturing apparatus 3, which is associated with the control data and the observed data, with the determined parameter.

The communicator 13 of the state detection apparatus 1 is connected to the semiconductor manufacturing apparatus 3 through a cable such as a communication line or a signal line, and transmits and receives the data to and from the semiconductor manufacturing apparatus 3 through the cable. In the present embodiment, the communicator 13 transmits the control data supplied from the processor 11 to the semiconductor manufacturing apparatus 3. Further, the communicator 13 receives the observed data transmitted from the semiconductor manufacturing apparatus 3, and supplies the received observed data to the processor 11.

The display 14 is configured by using a liquid crystal display or the like, and displays various images, characters, and the like based on the process of the processor 11. In the present embodiment, the display 14 displays, for example, various types of information related to an operation state of the semiconductor manufacturing apparatus 3, and displays a warning message or the like when abnormality is detected in the operation state of the semiconductor manufacturing apparatus 3.

The operator 15 receives a user operation and notifies the processor 11 of the received operation. For example, the operator 15 receives the user operation by an input device such as a mechanical button or a touch panel provided on a surface of the display 14. Further, for example, the operator 15 may be an input device such as a mouse and a keyboard, and these input devices may be configured to be detachable from the state detection apparatus 1.

The storage 12 may be an external storage apparatus connected to the state detection apparatus 1. Further, the state detection apparatus 1 may be a multi-computer including a plurality of computers, or may be a virtual machine virtually constructed by software. Further, the state detection apparatus 1 is not limited to the configuration described above, and may not include the display 14, the operator 15, and the like, for example.

In addition, in the state detection apparatus 1 of the present embodiment, the processor 11 reads and executes the program 12a stored in the storage 12, so that the control processor 11a, the parameter determinator 11b, the state detector 11c, the machine learning processor 11d, and the like are realized as software-like functional units in the processor 11.

The control processor 11a performs a process of controlling the operation of the semiconductor manufacturing apparatus 3 by generating the control data, transmitting the control data to the semiconductor manufacturing apparatus 3, and the like according to a predetermined semiconductor manufacturing procedure. For example, the control processor 11a transmits the control data that includes a command for driving the motor of the semiconductor manufacturing apparatus 3 and information on the driving amount thereof to the semiconductor manufacturing apparatus 3, thereby driving the motor of the semiconductor manufacturing apparatus 3 to move the fork holding the wafer and transfer the wafer. Further, the control processor 11a acquires the observed data transmitted from the semiconductor manufacturing apparatus 3 as a response to the control data, and stores the control data and the observed data in the history storage 12b of the storage 12 in association with each other. The control processor 11a repeatedly performs transmission of the control data and acquisition of the observed data, and accumulates time series information of a set of control data and observed data in the history storage 12b.

When one operation of the semiconductor manufacturing apparatus 3 under the control of the control processor 11a is ended, the parameter determinator 11b reads out the control data and the observed data related to the one operation from the history storage 12b. The parameter determinator 11b performs a process of determining parameters of the prediction model for predicting the observed data based on the control data. In the present embodiment, the prediction model is a model represented by the non-integer order differential equation represented by the following Equation (1).

$$y ( t ) = [ {μ}_{0} + {\sum }_{k = 1}^{K} {{μ}_{k} ( \frac{d}{dt} )}^{{v}_{k}} ] ( x ( t ) - {x}_{0} ) \qquad ( 1 )$$

In Equation (1), x(t) is time series input data (control data) input to the estimation model, and y(t) is time series observed data in accordance with the input control data. In Equation (1), μₖ and x₀ are coefficients, and vₖ is a differentiation order. μₖ, vₖ, and x₀ are parameters determined by the parameter determinator 11b. In addition, in Equation (1), K is a constant that determines the number of terms of the non-integer order differential equation, and is a value determined in advance by, for example, the developer of the information processing system according to the present embodiment based on characteristics of the semiconductor manufacturing apparatus 3.

The parameter determinator 11b successively inputs the time series control data to the estimation model of the non-integer order differential equation for which the initial values of the parameters are appropriately determined, and successively acquires the time series estimated data output by the estimation model. The parameter determinator 11b compares the observed data corresponding to the control data with the estimated data estimated by the estimation model to calculate an error, and determines the parameters of the estimation model by a difference method based on the calculated error. The parameter determinator 11b can calculate a gradient for each parameter based on the error, and can determine the parameters of the estimation model by using, for example, a method such as a steepest descent method, a quasi-Newtonian method, or a stochastic gradient descent (SGD) method based on the calculated gradient. Since the method of determining the parameters of the estimation model is an existing technique, a detailed description thereof will be omitted.

The parameter determinator 11b inputs the control data again to the estimation model based on the determined parameters to acquire estimated data, calculates the error between the estimated data and the observed data again, and compares the calculated error and a preset threshold value. When the calculated error is larger than the threshold value, the parameter determinator 11b updates the parameter based on the error. The parameter determinator 11b repeats the calculation of the error and the update of the parameters, and when the calculated error becomes smaller than the threshold value, the parameter in this case is finally determined as the parameter of the estimation model.

The state detector 11c detects the state of the semiconductor manufacturing apparatus 3 using the two methods in the present embodiment. In the first method, the state detector 11c calculates the fitness of the estimation model by using an estimation model in which the parameters determined by the parameter determinator 11b are set, and the control data and observed data used for determining the parameters. In the present embodiment, the state detector 11c inputs the control data to the estimation model to acquire the predicted data, and calculates the RMSE between the observed data and the predicted data as the fitness. In the present embodiment, since the RMSE is used as the fitness, the smaller the value of the fitness, the more the estimation model fits. The reciprocal of the RMSE may be used as the fitness, and in this case, the larger the value of the fitness, the more the estimation model fits. The state detector 11c detects the state of the semiconductor manufacturing apparatus 3 based on the comparison between the calculated RMSE and a predetermined threshold value. When the parameter determinator 11b calculates the RMSE as the error when determining the parameter, the state detector 11c does not need to recalculate the RMSE, and the state detector 11c may acquire the RMSE calculated by the parameter determinator 11b and compare the RMSE with the threshold value. For example, the state detector 11c can detect that the state of the semiconductor manufacturing apparatus 3 is abnormal when the RMSE exceeds the threshold value, and can detect that there is no abnormality when the RMSE does not exceed the threshold value.

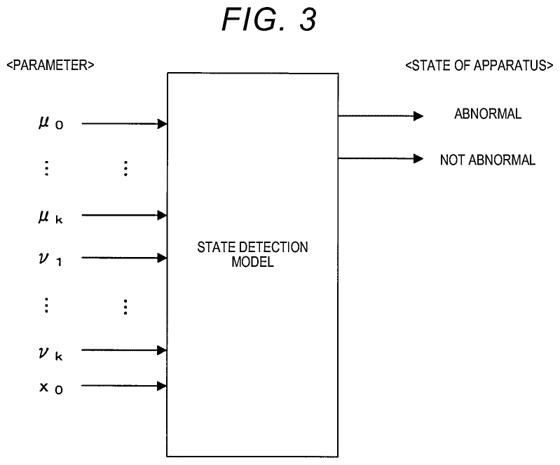

In the second method, the state detector 11c detects the state of the semiconductor manufacturing apparatus 3 by using the parameters determined by the parameter determinator 11b and the state detection model stored in the model information storage 12c. FIG. 3 is a schematic diagram illustrating an example of a state detection model according to the present embodiment. The state detection model according to the present embodiment is a classification model that receives parameters of the estimation model as inputs and outputs classification results obtained by classifying the state of the semiconductor manufacturing apparatus 3. In the present example, the estimation model receives parameters of μ₀, . . . μ_{K}, v₁, . . . , v_{K}, and x₀ shown in Equation (1) as inputs, and classifies the state of the semiconductor manufacturing apparatus 3 as either “abnormal” or “not abnormal”. The state detection apparatus 1 generates a state detection model by performing a so-called labeled machine learning process in advance, and stores information related to the generated state detection model in the model information storage 12c of the storage 12.

The state detector 11c inputs the parameters of the estimation model determined by the parameter determinator 11b to the state detection model, and acquires information related to the state of the semiconductor manufacturing apparatus 3, which is output by the state detection model. The state detection model outputs, for example, two numerical values (confidence, likelihood, and the like) corresponding to the two states of “abnormal” and “not abnormal”, and the state detector 11c can set a state corresponding to a larger one of the two numerical values as the state of the semiconductor manufacturing apparatus 3.

In addition, the outputs of the state detection model may be categories assigned to a plurality of states of the semiconductor manufacturing apparatus 3. For example, when three types of states (categories) of failure, maintenance, and normal exist as the states of the semiconductor manufacturing apparatus 3, “T” can be assigned to the failure, “M” can be assigned to the maintenance, and “R” can be assigned to the normal. In the present example, the category is represented by, for example, characters such as “T”, “M”, “R”, or the like, but the category is not limited thereto, and may be represented by numerical values such as “0”, “1”, “2”, or the like. The state detection model is subjected to machine learning in advance to predict these categories.

Further, the output of the state detection model may be a numerical value within a predetermined range related to the state of the semiconductor manufacturing apparatus 3. For example, various numerical values such as the probability that the semiconductor manufacturing apparatus 3 has failed, the probability that maintenance has been performed, the probability that a failure occurs within a predetermined period, the number of days before the failure, and the number of days since the maintenance has been performed may be output from the state detection model.

The state detector 11c performs state detection of the semiconductor manufacturing apparatus 3 by the first method and the second method described above, and finally detects the occurrence of abnormality in the state of the semiconductor manufacturing apparatus 3 when the detection result indicating the occurrence of abnormality in the state of the semiconductor manufacturing apparatus 3 is obtained by at least either method. The state detector 11c finally detects no abnormality in the state of the semiconductor manufacturing apparatus 3 when the detection results indicating no abnormality are obtained by both the first method and the second method. When the abnormality is detected in the state of the semiconductor manufacturing apparatus 3, the state detector 11c performs processes such as displaying a warning message or the like on the display 14 and stopping the operation of the semiconductor manufacturing apparatus 3.

The state detector 11c may perform state detection using both the fitness and the parameters, instead of performing state detection (detection of the presence of an abnormality) individually with respect to the fitness (RMSE) and the parameters as described above. For example, the state detector 11c can use a learning model in which machine learning has been performed in advance, to receive the fitness and the parameters as inputs and classify the state of the semiconductor manufacturing apparatus 3.

The machine learning processor 11d performs a process of generating a state detection model by performing a machine learning process using the learning data stored in the learning data storage 12d of the storage 12 before performing state detection of the semiconductor manufacturing apparatus 3. The learning data stored in the learning data storage 12d is data obtained by associating the parameters of the estimation model with the state of the semiconductor manufacturing apparatus 3. The machine learning processor 11d uses the learning data to perform a so-called labeled machine learning process to generate a state detection model. Since the labeled machine learning process is an existing technique, a detailed description thereof will be omitted in the present embodiment. The machine learning processor 11d stores information related to the state detection model generated through machine learning in the model information storage 12c.

### <Process of Generating State Detection Model>

In the information processing system according to the present embodiment, a process of collecting and generating learning data for generating a state detection model through machine learning is performed before the state detection apparatus 1 performs state detection of the semiconductor manufacturing apparatus 3. Further, in the information processing system, a process of generating a state detection model by machine learning using the learning data is performed in advance. In the present embodiment, it is described that the process related to the generation of the state detection model is performed by the state detection apparatus 1, but the process is not limited thereto, and the process may be performed by an apparatus other than the state detection apparatus 1.

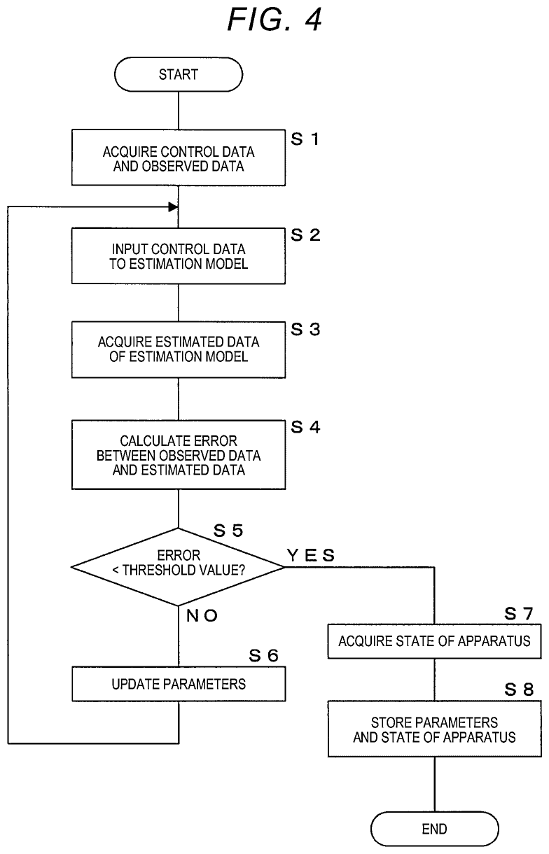

FIG. 4 is a flowchart illustrating an example of a procedure of a learning data generation process performed by the state detection apparatus according to the present embodiment. The processor 11 of the state detection apparatus 1 according to the present embodiment stores and accumulates the control data and the observed data in the history storage 12b along with the operation of the semiconductor manufacturing apparatus 3. The machine learning processor 11d of the processor 11 appropriately acquires control data and observed data for one operation of the semiconductor manufacturing apparatus 3 from among these data stored in the history storage 12b (step S1).

The parameter determinator 11b of the processor 11 inputs the control data acquired in step S1 to the estimation model of a non-integer order differential equation (step S2), and acquires the estimated data output by the estimation model (step S3). The parameter determinator 11b calculates an error between the observed data acquired in step S1 and the estimated data acquired in step S3 (step S4). The parameter determinator 11b determines whether the error calculated in step S4 is smaller than a predetermined threshold value (step S5). When the error is larger than the threshold value (S5: NO), the parameter determinator 11b updates the parameters of the estimation model such that the error is small (step S6), and returns the process to step S2. The parameter determinator 11b repeatedly updates the parameters by repeating the process of steps S2 to S6, and the process proceeds to step S7 when it is determined that the error is smaller than the threshold value (S5: YES).

The machine learning processor 11d acquires information related to the operation state of the semiconductor manufacturing apparatus 3 with respect to the set of control data and observed data acquired in step S1 (step S7). In this case, the information related to the operation state of the semiconductor manufacturing apparatus 3 is the presence or absence of abnormality of the semiconductor manufacturing apparatus 3 in the present embodiment. The developer or administrator of the information processing system according to the present embodiment can determine the presence or absence of abnormality in the semiconductor manufacturing apparatus 3 with respect to the set of control data and observed data. For example, information, which is obtained by setting data “1” with abnormality and setting data “O” with no abnormality by the developer, the administrator, or the like, can be regarded as the information related to the operation state of the semiconductor manufacturing apparatus 3. The work performed by the developer, the administrator, or the like is a work so-called annotation. The annotation work may be performed before the learning data generation process shown in the flowchart is performed, or the annotation work may be performed at the same time by receiving an input from the developer, the administrator, or the like in the course of the learning data generation process.

The machine learning processor 11d stores, as the learning data, the parameters of the estimation model determined through the process in steps S2 to S6 and the state of the semiconductor manufacturing apparatus 3 acquired in step S7 in association with each other, in the learning data storage 12d (step S8), and ends the process. The process of the flowchart illustrated in FIG. 4 is a procedure of generating one learning data, and the state detection apparatus 1 can generate a plurality of learning data by repeating the process.

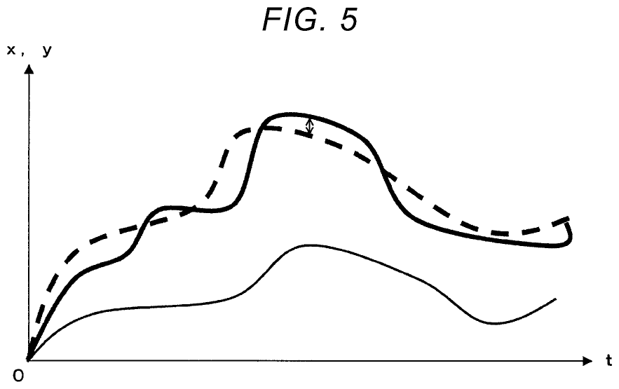

FIG. 5 is a schematic diagram for explaining an outline of a parameter determination process of an estimation model according to the present embodiment. FIG. 5 illustrates a graph in which a horizontal axis represents time t, and a vertical axis represents a value of control data x or observed data y. In FIG. 5, the control data x input to the semiconductor manufacturing apparatus 3 is indicated by a thin solid line, the observed data output from the semiconductor manufacturing apparatus 3 is indicated by a thick solid line, and the estimated data, which is obtained by estimating the observed data y by the estimation model based on the control data x, is indicated by a broken line. The illustrated graph shows the control data x, the observed data y, and the estimated data for one operation of the semiconductor manufacturing apparatus 3. Further, an error of the observed data y and the estimated data at a certain point in time during one operation are indicated by thin-line double-headed arrows.

When there are N sets of control data x and observed data y per operation of the semiconductor manufacturing apparatus 3, the state detection apparatus 1 acquires N estimated data by acquiring the estimated data about N control data X using the estimation model, respectively. The state detection apparatus 1 can acquire N error data by calculating a difference between the two data corresponding to the N observed data and the N estimated data. The state detection apparatus 1 calculates RMSE by calculating, for example, the square root of a squared average value with respect to the N error data, and the RMSE value can be used as an error (error calculated in step S4 of the flowchart of FIG. 4) with respect to the entire operation.

In the present example, a case of one-dimensional control data x and one-dimensional observed data y have been described by way of example, but each of the control data and the observed data may be two-dimensional or more vectors. Further, the dimension of the control data does not need to coincide with the dimension of the observed data. For example, the control data may be one-dimensional, and the observed data may be three-dimensional, and in this case, the estimation model serves as a model that receives a one-dimensional value as an input and outputs three-dimensional vectors.

By repeating update of parameters of non-integer order differential equation of the estimation model in a direction in which the calculated error is reduced, the state detection apparatus 1 can obtain the parameters of the estimation model that accurately estimates the observed data of the operation of the semiconductor manufacturing apparatus 3 with respect to the control data. The state detection apparatus 1 generates, as learning data, data in which the parameters of the estimation model obtained in this way are associated with information indicating the state of the semiconductor manufacturing apparatus 3 based on the control data and the observed data at this time. The state detection apparatus 1 generates and accumulates as much learning data as possible, and performs the machine learning process using the learning data, thereby generating a state detection model.

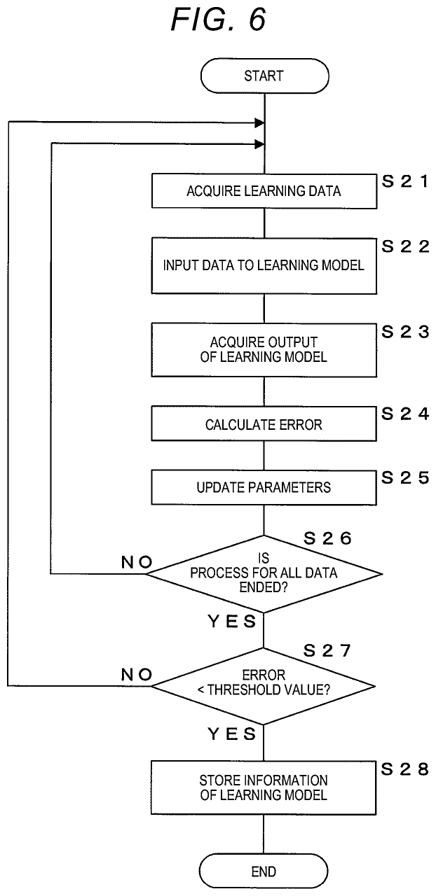

FIG. 6 is a flowchart illustrating an example of a procedure of a state detection model generation process performed by the state detection apparatus 1 according to the present embodiment. The machine learning processor 11d of the processor 11 of the state detection apparatus 1 according to the present embodiment acquires one learning data as appropriate from among a plurality of learning data stored in the learning data storage 12d of the storage 12 (step S21). The machine learning processor 11d inputs the data of the parameters included in the learning data acquired in step S1 to the learning model (untrained or in the middle of training) (step S22). The learning model is configured to output numerical values, categories, or the like corresponding to the state of the semiconductor manufacturing apparatus 3 with respect to an input of the parameters, and the machine learning processor 11d acquires an output of the learning model with respect to the data input in step S22 (step S23). The machine learning processor 11d calculates the error (cross-entropy error) between the numerical value, category, or the like corresponding to the state of the semiconductor manufacturing apparatus 3 included in the learning data acquired in step S21, and the numerical value, category, or the like output by the learning model acquired in step S23 (step S24). Based on the error calculated in step S24, the machine learning processor 11d updates the parameters of the learning model such that the error becomes smaller (step S25).

The machine learning processor 11d determines whether the process of steps S21 to S25 has been ended with respect to all the learning data stored in the learning data storage 12d (step S26). When the process has not been ended with respect to all the learning data (step S26: NO), the machine learning processor 11d returns the process to step S21, acquires another learning data, and performs the same process. When the process has been ended with respect to all the learning data (step S26: YES), the machine learning processor 11d determines whether the error calculated last is smaller than a predetermined threshold value (step S27). When the error is larger than the threshold value (S27: NO), the machine learning processor 11d returns the process to step S21, and performs the process of steps S21 to S26 using the same learning data. When the error is smaller than the threshold value (S27: YES), the machine learning processor 11d stores the information of the learning model that includes the finally determined parameters as the information of the state detection model in the model information storage 12c (step S28), and ends the process.

### <State Detection Process>

The state detection apparatus 1 according to the present embodiment controls the operation of the semiconductor manufacturing apparatus 3, and performs a process of detecting the state of the semiconductor manufacturing apparatus 3 (that is, the presence or absence of abnormality in the present embodiment) with respect to one completed operation, by using the trained state detection model. The process of detecting the state of the state detection apparatus 1 is performed each time one operation of the semiconductor manufacturing apparatus 3 is completed, for example. In addition, the state detection apparatus 1 according to the present embodiment also performs state detection based on the fitness of the estimation model in which the parameters have been determined based on the control data and observed data of the semiconductor manufacturing apparatus 3.

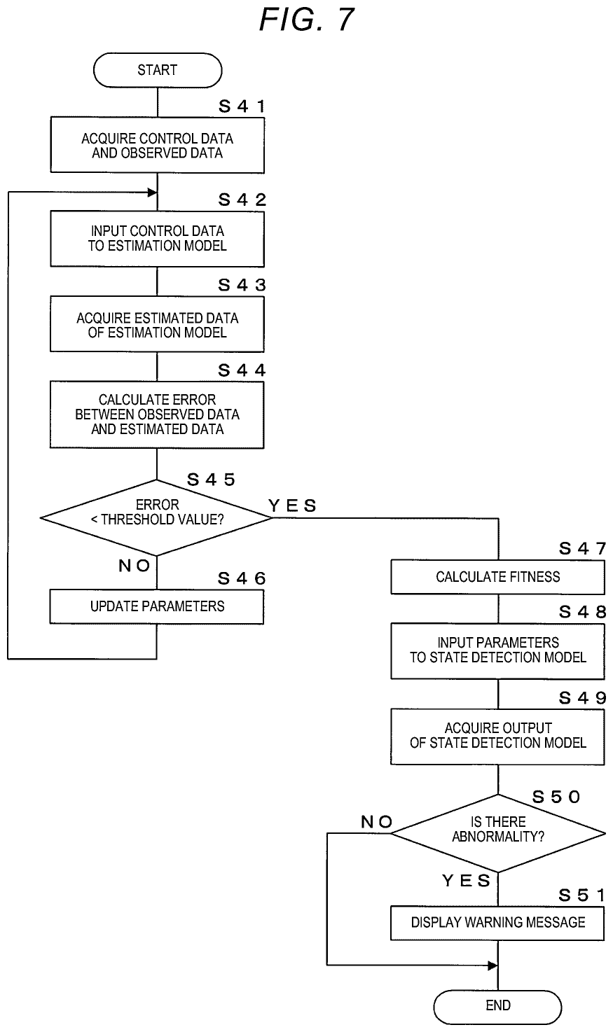

FIG. 7 is a flowchart illustrating an example of a procedure of a state detection process performed by the state detection apparatus 1 according to the present embodiment. The control processor 11a of the processor 11 of the state detection apparatus 1 according to the present embodiment controls the operation by transmitting the control data to the semiconductor manufacturing apparatus 3. The control processor 11a acquires the observed data transmitted from the semiconductor manufacturing apparatus 3 as the operation result, and stores the control data and the observed data in the history storage 12b. The state detector 11c of the processor 11 acquires control data and observed data for one operation of the semiconductor manufacturing apparatus 3, which has operated just before, from among these data stored in the history storage 12b (step S41).

The parameter determinator 11b of the processor 11 inputs the control data acquired in step S41 to a non-integer order differential equation estimation model (step S42), and acquires the estimated data output by the estimation model (step S43). The parameter determinator 11b calculates an error between the observed data acquired in step S41 and the estimated data acquired in step S43 (step S44). The parameter determinator 11b determines whether the error calculated in step S44 is smaller than a predetermined threshold value (step S45). When the error is larger than the threshold value (S45: NO), the parameter determinator 11b updates the parameters of the estimation model such that the error is small (step S46), and returns the process to step S42. The parameter determinator 11b repeatedly updates the parameters by repeating the process of steps S42 to S46, and the process proceeds to step S47 when it is determined that the error is smaller than the threshold value (S45: YES). The process in steps S42 to S46 performed by the parameter determinator 11b in the flowchart is the same as the process in steps S2 to S6 performed by the parameter determinator 11b in the flowchart illustrated in FIG. 4.

The state detector 11c calculates the fitness with respect to the estimation model in which the parameters have been determined through the process in steps S42 to S46 (step S47). In this case, the state detector 11c can input the control data to the estimation model in which the parameters have been determined to acquire estimated data, and can calculate the RMSE of the observed data and the estimated data to set the calculated RMSE as the fitness.

Furthermore, the state detector 11c inputs the parameters of the estimation model determined through the process in steps S42 to S46 to the state detection model stored in advance in the model information storage 12c (step S48). The state detector 11c acquires information related to the state of the semiconductor manufacturing apparatus 3 output from the state detection model (step S49). The information output by the state detection model in the present embodiment is information indicating the presence or absence of abnormality with respect to the operation of the semiconductor manufacturing apparatus 3.

The state detector 11c determines whether there is abnormality in the operation of the semiconductor manufacturing apparatus 3 based on the fitness calculated in step S47 and the information acquired in step S48 (step S50). For example, the state detector 11c can determine that there is abnormality in the operation of the semiconductor manufacturing apparatus 3, when the RMSE calculated in step S47 exceeds a preset threshold value or when the information acquired from the state detection model in step S49 is “abnormal”. In addition, the state detector 11c can determine that there is no abnormality in the operation of the semiconductor manufacturing apparatus 3, when the RMSE calculated as the fitness in step S47 does not exceed a preset threshold value and when the information acquired from the state detection model in step S49 is “not abnormal”. When there is no abnormality in the operation of the semiconductor manufacturing apparatus 3 (S50: NO), the state detector 11c ends the process. When there is an abnormality (S50: YES), the state detector 11c displays a warning message or the like on the display 14 (step S51), for example, and ends the process.

### Modification Examples

The state detection apparatus 1 according to the present embodiment is not limited to the configuration described above, and various modifications may be adopted. Hereinafter, some modifications of the state detection apparatus 1 will be described. However, the configuration of the state detection apparatus 1 is not limited to the configuration described above and the configuration of the following modifications.

### (Modification 1)

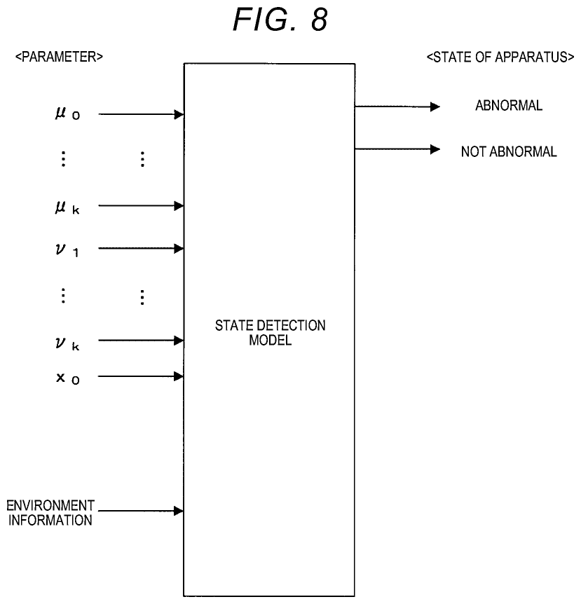

FIG. 8 is a schematic diagram illustrating an example of the state detection model included in the state detection apparatus 1 according to Modification 1. The state detection model according to Modification 1 receives parameters of the estimation model as inputs, and receives environment information as an input to output information related to the state of the semiconductor manufacturing apparatus 3. The environment information may include, for example, information related to an operation mode (such as a high speed mode or a low speed mode) of the semiconductor manufacturing apparatus 3, information related to a wafer handled by the semiconductor manufacturing apparatus 3, or information related to an environment around the semiconductor manufacturing apparatus 3 (such as temperature or humidity). The semiconductor manufacturing apparatus 3 transmits the environment information, together with the observed data, to the state detection apparatus 1. The state detection apparatus 1 stores the environment information in the history storage 12b in association with the control data and the observed data.

The learning data used for machine learning for generating the state detection model according to Modification 1 is data obtained by associating the parameters and the environment information of the estimation model with the state of the semiconductor manufacturing apparatus 3. The state detection apparatus 1 generates learning data by associating information related to the state of the semiconductor manufacturing apparatus 3, which is set by the developer or administrator with the parameters determined based on the control data and observed data stored in the history storage 12b and the environment information stored in the history storage 12b.

Further, when state detection of the semiconductor manufacturing apparatus 3 is performed, the state detection apparatus 1 according to Modification 1 acquires information related to the state of the semiconductor manufacturing apparatus 3, which is output by the state detection model, by determining the parameters of the estimation model based on the control data input to the semiconductor manufacturing apparatus 3 and the observed data acquired from the semiconductor manufacturing apparatus 3, acquiring the environment information from the semiconductor manufacturing apparatus 3, and inputting the parameters and the environment information to the state detection model.

### (Modification 2)

The state detection apparatus 1 according to Modification 2 updates the parameters of the estimation model not with respect to all parameters, but with respect to some parameters. That is, for example, when there are 10 parameters of the estimation model, the state detection apparatus 1 according to Modification 2 determines seven parameters based on the control data and the observed data, and uses preset values for the remaining three parameters. The fixed parameters that are not dynamically determined are set in advance by, for example, the developer of the information processing system according to the present embodiment.

Further, when the environment information described in Modification 1 is used, the state detection apparatus 1 according to Modification 2 may prepare a plurality of fixed parameters according to the environment information. The state detection apparatus 1 reads the fixed parameters in accordance with the environment information acquired from the semiconductor manufacturing apparatus 3, and determines the remaining parameters as a part of the parameters of the estimation model based on the control data and the observed data.

### (Modification 3)

As the estimation model according to the present embodiment, a non-integer order differential equation model based on Equation (1) is adopted. However, as the estimation model, a model based on various equations may be adopted instead of the model based on Equation (1). Several equations that may be adopted as the estimation model are described below. In the following equation, γ₁, . . . , γ_{K} and μ₁, . . . , μₖ are coefficients, and θ₁, . . . , θₖ and v₁, . . . , v_{K} are differentiation orders. K is an integer that determines the complexity of the model, and is a value determined in advance by, for example, the developer of the information processing system according to the present embodiment. For example, f and g are functions for performing a pre-process of data by an elementary function, linear calculation, a statistical process, principal component analysis, a machine learning model, or the like. The parameters included in these functions may also be used as parameters of an estimation model.

$$[ {γ}_{0} + {\sum }_{k = 1}^{L} {{γ}_{k} ( \frac{d}{dt} )}^{{θ}_{k}} ] f ( y ( t ) , t ) = [ {μ}_{0} + {\sum }_{k = 1}^{K} {{μ}_{k} ( \frac{d}{dt} )}^{{v}_{k}} ] g ( x ( t ) , t ) \qquad ( 2 )$$

Equation (2) is a more generalized equation for Equation (1). Equation (2) is Equation (1) where L=0, γ₀=1, f(y, t)=y, g(x, t)=x−x₀.

$$[ {γ}_{0} + {\sum }_{k = 1}^{L} {{γ}_{k} ( \frac{d}{dt} )}^{{θ}_{k}} ] ( y ( t ) - {y}_{0} ) = [ {μ}_{0} + {\sum }_{k = 1}^{K} {{μ}_{k} ( \frac{d}{dt} )}^{{v}_{k}} ] ( x ( t ) - {x}_{0} ) \qquad ( 3 )$$

In Equation (3), x₀ and y₀ can also be parameters of the estimation model.

$$[ {γ}_{0} + {\sum }_{k = 1}^{L} {{γ}_{k} ( \frac{d}{dt} )}^{{θ}_{k}} ] Θ ( t - {t}_{0} ) ( y ( t ) - {y}_{0} ) = [ {μ}_{0} + {\sum }_{k = 1}^{K} {{μ}_{k} ( \frac{d}{dt} )}^{{v}_{k}} ] Θ ( t - {t}_{0} ) ( x ( t ) - {x}_{0} ) \qquad ( 4 )$$

$$Θ ( t ) = \{ \begin{matrix}1 & ( t \geq 0 ) \\ 0 & ( t < 0 )\end{matrix}$$

In Equation (4), to can also be used as parameters of the estimation model.

$$[ {γ}_{0} + {\sum }_{k = 1}^{L} {{γ}_{k} ( \frac{d}{dt} )}^{{θ}_{k}} ] {\sum }_{n = 0}^{∞} {{a}_{n} ( y ( t ) - {y}_{0} )}^{n} = [ {μ}_{0} + {\sum }_{k = 1}^{K} {{μ}_{k} ( \frac{d}{dt} )}^{{v}_{k}} ] {\sum }_{m = 0}^{∞} {{b}_{m} ( x ( t ) - {x}_{0} )}^{m} \qquad ( 5 )$$

Equation (5) is used when x and y are one component. In Equation (5), aₙ, bₙ, x₀, and y₀ may be parameters of the estimation models, or may be constants determined in advance.

$$[ {γ}_{0} + {\sum }_{k = 1}^{L} {{γ}_{k} ( \frac{d}{dt} )}^{{θ}_{k}} ] A ( y ( t ) - {y}_{0} ) = [ {μ}_{0} + {\sum }_{k = 1}^{K} {{μ}_{k} ( \frac{d}{dt} )}^{{v}_{k}} ] B ( x ( t ) - {x}_{0} ) \qquad ( 6 )$$

In Equation (6), A is a d₁ dimensional matrix, B is a d₂ dimensional matrix, y(t) and y₀ are d₁ dimensional vectors, and x(t) and x₀ are d₂ dimensional vectors.

$$[ {γ}_{0} + {\sum }_{k = 1}^{L} {{γ}_{k} ( \frac{d}{dt} )}^{{θ}_{k}} ] {F}_{A} ( y ( t ) - {y}_{0} ) = [ {μ}_{0} + {\sum }_{k = 1}^{K} {{μ}_{k} ( \frac{d}{dt} )}^{{v}_{k}} ] {G}_{B} ( x ( t ) - {x}_{0} ) \qquad ( 7 )$$

In Equation (7), F and G are neural networks, and A and B are weight parameters of the neural networks. The weight parameter may be determined in advance by a method such as machine learning.

### (Modification 4)

In the information processing system according to the present embodiment described above, the state detection apparatus 1 updates the parameters of the estimation model based on the control data and the observed data each time the state detection of the semiconductor manufacturing apparatus 3 is performed, and the state is detected based on the updated parameters. However, the present disclosure is not limited thereto. The state detection apparatus 1 of the information processing system according to Modification 4 does not update the parameters of the estimation model each time the state detection of the semiconductor manufacturing apparatus 3 is performed, but detects the state of the semiconductor manufacturing apparatus 3 by using the estimation model in which the parameters have been determined in advance.

The state detection apparatus 1 according to Modification 4 includes an estimation model in which the parameters have been determined in advance. The state detection apparatus 1 acquires control data and observed data with respect to the semiconductor manufacturing apparatus 3 that is a target of state detection, and inputs the acquired control data to the estimation model to acquire predicted data of the observed data. The state detection apparatus 1 can compare the observed data and the predicted data, and can determine that the state of the semiconductor manufacturing apparatus 3 is abnormal, for example, when a difference between the observed data and the predicted data exceeds a threshold value.

The estimation model of the state detection apparatus 1 according to Modification 4 determines parameters based on, for example, the control data and observed data acquired during past operations of the semiconductor manufacturing apparatus 3 that is a target of state detection. Further, for example, the estimation model may determine parameters based on the control data and observed data acquired by another apparatus having the same configuration as the semiconductor manufacturing apparatus 3 that is a target of state detection.

### SUMMARY

In the information processing system according to the present embodiment having the configuration described above, control data (input data) input to the semiconductor manufacturing apparatus (target apparatus) 3 and observed data of the operation of the semiconductor manufacturing apparatus 3 are acquired by the control processor (first acquirer) 11a of the state detection apparatus 1. The parameter determinator (determinator) 11b determines the parameters of the estimation model that estimates observed data from the control data based on the acquired control data and observed data, and the state detector (detector) 11c detects the state of the semiconductor manufacturing apparatus 3 based on the determined parameters. As a result, the information processing system can be expected to realize more accurate state detection of the semiconductor manufacturing apparatus 3 as compared to when the state based only on input/output data with respect to the semiconductor manufacturing apparatus 3 is detected.

For example, when there are a plurality of operation modes of the semiconductor manufacturing apparatus 3, the distribution of input/output data is dispersed in a plurality of clusters (groups) or a continuous range, and it is difficult to detect an abnormal or normal state based on statistics or the like. In the information processing system according to the present embodiment, since a relationship itself between input/output data can be trained, the relationship is unlikely to be affected even when there are a plurality of operation modes.

For example, when the semiconductor manufacturing apparatus 3 includes a robot arm that moves three-dimensionally, and the robot arm picks up objects that are irregularly disposed and regularly arranges the objects in one place, the robot arm completely differently moves each time. Therefore, when input or output data that deviates from the previous statistics is obtained, the input or output data is generally difficult to determine whether the robot arm is abnormal or whether the robot arm situation is normal and the position, weight, or the like of the object is a previously unknown value. The information processing system according to the present embodiment can be expected to perform state detection in which the friction of the joint of the robot arm is excessively large or the motor reaches the end of life, based on the relationship between the input and output data in principle, regardless of the disposition of the objects and how the robot arm moves.

Further, in the information processing system according to the present embodiment, the state detection model (learning model) is generated in advance through machine learning using learning data in which the parameters of the estimation model and the state of the semiconductor manufacturing apparatus 3 are associated with each other. The state detection model is a learning model that receives the parameters of the estimation model as inputs and outputs the state of the semiconductor manufacturing apparatus 3. The state detection apparatus 1 includes a state detection model that is generated in advance, and performs state detection by inputting the parameters of the estimation model, which are determined based on the control data and the observed data, to the state detection model, and acquiring the state of the semiconductor manufacturing apparatus 3 that is output by the state detection model. Accordingly, the information processing system can be expected to estimate the state of the apparatus from variation in parameters even when the fitness does not change significantly and only the parameters vary.

Further, in the information processing system according to the present embodiment, the state detector (second acquirer and calculator) 11c of the state detection apparatus 1 acquires estimated data about the control data for the estimation model in which the parameters have been determined, and calculates the fitness (for example, RMSE) based on the observed data and the estimated data. The state detector 11c detects the state of the semiconductor manufacturing apparatus 3 based on the calculated fitness. In addition to the state detection based on the parameters of the estimation model, the information processing system can be expected to accurately perform state detection of the semiconductor manufacturing apparatus 3 by performing the state detection based on the fitness of the estimation model.

Further, in the information processing system according to the present embodiment, the non-integer order differential equation model is used as the estimation model. Since the non-integer order differential equation model can accurately model the input/output characteristics of the target apparatus such as the semiconductor manufacturing apparatus 3 as compared to the integer order differential equation model, it can be expected that the state detection apparatus 1 can accurately perform the state detection of the semiconductor manufacturing apparatus 3. Since the non-integer order differential equation includes an ordinary integer order differential equation (such as an ordinary differential equation) as a special case in which the differentiation order is limited to a non-negative integer, the non-integer order differential equation has a larger space for solution than the integer order differential equation and has a higher descriptive ability as a model than a case of the same number of parameters. In addition, the non-integer order differential equation has well-known results used for the analysis of viscoelastic bodies, and can be expected to be superior to an ordinary differential equation model for the modeling of the friction of a contact portion including grease or the like.

The present embodiment has been described with respect to a configuration in which the state detection apparatus 1 performs state detection of the semiconductor manufacturing apparatus 3 by two methods, that is, state detection based on the parameters of the estimation model and state detection based on the fitness of the estimation model, but the present disclosure is not limited thereto. The state detection apparatus 1 may be configured to perform state detection by any one of the two methods, or may be configured to perform state detection by three or more methods that are different from the two methods.

Further, in the present embodiment, the target apparatus for performing the state detection by the state detection apparatus 1 is the semiconductor manufacturing apparatus 3. However, the present disclosure is not limited thereto, and the target apparatus may be any apparatus different from the semiconductor manufacturing apparatus 3. The target apparatus may be any type of apparatus capable of performing any operation according to input data and outputting a result of the operation as observed data.

Further, in the present embodiment, the estimation model is a non-integer order differential equation model, but the present disclosure is not limited thereto. The estimation model may be, for example, an integer order differential equation model, or may be, for example, a machine learning model, or may be a model represented by any other equation. For example, when the operation of the state detection target apparatus is not so complicated, sufficient accuracy may be obtained by using the integer order differential equation model without using the non-integer order differential equation model.

Further, in the present embodiment, the state detection apparatus 1 is configured to perform state detection based on the parameters of the estimation model by using a state detection model in which machine learning has been performed in advance, but the present disclosure is not limited thereto. The state detection apparatus 1 may determine the parameters of the estimation model based on, for example, the control data and the observed data, and may perform state detection of the semiconductor manufacturing apparatus 3 by comparing the determined parameters with a predetermined threshold value. The threshold value to be compared with the parameters can be determined in advance by, for example, the developer or the administrator of the information processing system. Further, for example, the state detection apparatus 1 may store a history of the determined parameters of the estimation model, and may detect the state of the semiconductor manufacturing apparatus 3 based on changes in values of the parameters in a predetermined period. Further, for example, the state detection apparatus 1 may detect the state of the semiconductor manufacturing apparatus 3 in accordance with whether one or more parameters include a value that deviates from a predetermined range (that is, a so-called outlier), or in accordance with the number of occurrences of the outlier in a predetermined period, or the like. Any method may be adopted as the state detection method of the semiconductor manufacturing apparatus 3 based on the parameters of the estimation model.

The embodiments disclosed herein are exemplary in all respects and can be considered to be not restrictive. The scope of the present disclosure is indicated by the claims, not the above-described meaning, and is intended to include all modifications within the meaning and scope equivalent to the claims.

The features described in each embodiment can be combined with each other. In addition, the independent and dependent claims set forth in the claims can be combined with each other in any and all combinations, regardless of the reciting format. Furthermore, the claims use a format of describing claims that recite two or more other claims (multi-claim format). However, the present disclosure is not limited thereto. The claims may also be described using a format of multi-claims reciting at least one multi-claim (multi-multi claims).

According to the present disclosure, it can be expected to accurately detect a state of a target apparatus such as a semiconductor manufacturing apparatus.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

1. A state detection apparatus comprising:
a first acquirer that acquires input data of a target apparatus and observed data of an operation of the target apparatus;
a determinator that determines parameters of an estimation model that estimates the observed data from the input data based on the input data and the observed data acquired by the first acquirer; and
a detector that detects a state of the target apparatus based on the parameters determined by the determinator.

2. The state detection apparatus according to claim 1, further comprising:
a learning model in which machine learning is performed to receive the parameters of the estimation model that estimates the observed data of the operation of the target apparatus from the input data of the target apparatus as inputs, and to output the state of the target apparatus,
wherein the detector detects the state of the target apparatus by inputting the parameters determined by the determinator to the learning model, and acquiring the state of the target apparatus, which is output by the learning model.

3. The state detection apparatus according to claim 2,
wherein the learning model is a learning model which is generated in advance through machine learning by using learning data in which the parameters of the estimation model that estimates the observed data of the operation of the target apparatus from the input data of the target apparatus are associated with the state of the target apparatus.

4. The state detection apparatus according to claim 1, further comprising:
a second acquirer that acquires estimated data of the observed data output by the estimation model by inputting the input data acquired by the first acquirer to the estimation model in which the parameters have been determined by the determinator; and
a calculator that calculates fitness of the estimation model based on the observed data acquired by the first acquirer and the estimated data acquired by the second acquirer,
wherein the detector detects the state of the target apparatus based on the parameters determined by the determinator and the fitness calculated by the calculator.

5. The state detection apparatus according to claim 1,
wherein the estimation model is a non-integer order differential equation model.

6. The state detection apparatus according to claim 1,
wherein the state of the target apparatus detected by the detector includes a degree of abnormality related to the operation of the target apparatus.

7. The state detection apparatus according to claim 1,
wherein information related to the state of the target apparatus detected by the detector is displayed on a display.

8. A state detection method comprising, via an information processing apparatus:
acquiring input data of a target apparatus and observed data of an operation of the target apparatus;
determining parameters of an estimation model that estimates the observed data from the input data based on the acquired input data and observed data; and
detecting a state of the target apparatus based on the determined parameters.

9. A generation method of a learning model comprising, via an information processing apparatus:
acquiring learning data in which parameters of an estimation model that estimates observed data of an operation of a target apparatus from input data of the target apparatus are associated with a state of the target apparatus; and
generating a learning model that receives the parameters of the estimation model that estimates the observed data of the operation of the target apparatus from the input data of the target apparatus as inputs, and outputs the state of the target apparatus, through machine learning using the acquired learning data.

10. A non-transitory recording medium in which a computer program is recorded, the computer program for causing a computer to execute processes of:
acquiring input data of a target apparatus and observed data of an operation of the target apparatus;
determining parameters of an estimation model that estimates the observed data from the input data based on the acquired input data and observed data; and
detecting a state of the target apparatus based on the determined parameters.

11. A non-transitory recording medium in which a computer program is recorded, the computer program for causing a computer to execute processes of:
acquiring learning data in which parameters of an estimation model that estimates observed data of an operation of a target apparatus from input data of the target apparatus are associated with a state of the target apparatus; and
generating a learning model that receives the parameters of the estimation model that estimates the observed data of the operation of the target apparatus from the input data of the target apparatus as inputs, and outputs the state of the target apparatus, through machine learning using the acquired learning data.
